(19) United States
(12) Patent Application Publication
(10) Pub. No.: US 2007/0008698 A1
(43) Pub. Date: Jan. 11, 2007

(54) Computer housing having heat-dissipating gate

(76) Inventor: Chin-Chuan Kao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/175,207

(22) Filed: Jul. 7, 2005

(51) Int. Cl. G06F 1/20

(52) U.S. Cl. 361/687; 361/695; 165/80.3

(57) ABSTRACT

This invention relates a computer housing, which comprises a body and a heat-dissipating gate. The body has at least one opening formed with two holders on two opposite sides of the opening. In addition, the heat-dissipating gate is installed between the holders and comprises a plurality of blades, a transmission device and a motor. Each of the blades has a shaft connected with the holders so that the blades are rotatable between the holders. The transmission device is provided for transmitting the blades to rotate synchronously and the motor is provided for driving the transmission device. Accordingly, heat generated within the computer housing can be dissipated out of the computer housing efficiently by applying the heat-dissipating gate to control an open status of the opening.

### TECHNICAL FIELD

This invention relates generally to computer housings and more particularly to the computer housings, which require heat-dissipating functions.

### BACKGROUND OF THE INVENTION

Conventional computers generally install fans in their back panels to dissipate heat, which is generated from devices installed within the computers during operation. Because power consumptions of the devices, such as CPUs, are increased greatly, additional fans installed in front panels of the conventional computers are necessary.

However, the fans usually generate noises during operations and the noises directly pass to users without any protections. Therefore, to be in such noisy environments chronically, the users' hearing can be damaged by the noises, which also influence the users' moods as well.

### SUMMARY OF INVENTION

The primary objective of the present invention is to provide a computer housing, which comprises a heat-dissipating gate for automatically and efficiently dissipating heat generated within the computer housing out of the computer housing.

More particularly, the computer housing further comprises a body, which has at least one opening and two holders. The holders are respectively formed on two opposite sides of the opening. In addition, the heat-dissipating gate is installed between the holders and comprises a plurality of blades, a transmission device and a motor. Each of the blades has a shaft connected with the holders so that the blades are rotatable between the holders. The transmission device is provided for transmitting the blades to rotate synchronously and the motor is provided for driving the transmission device.

Therefore, the heat within the computer housing can be dissipated out of the computer housing efficiently by applying the blades of the heat-dissipating gate to control an open status of the opening, according to different heat-dissipating requirements of computers.

### BRIEF DESCRIPTION OF DRAWINGS

The invention will be more clearly understood after referring to the following detailed description read in conjunction with the drawings wherein:

FIG. 1 is a perspective view of a first embodiment of the present invention;

FIG. 2 is a schematic view of the first embodiment of the present invention, showing movements of blades;

FIG. 3 is a plan view of a second embodiment of the present invention; and

FIG. 4 is an exploded view of a third embodiment of the present invention.

### DETAILED DESCRIPTION OF PREFERRED EMBODIMENTS

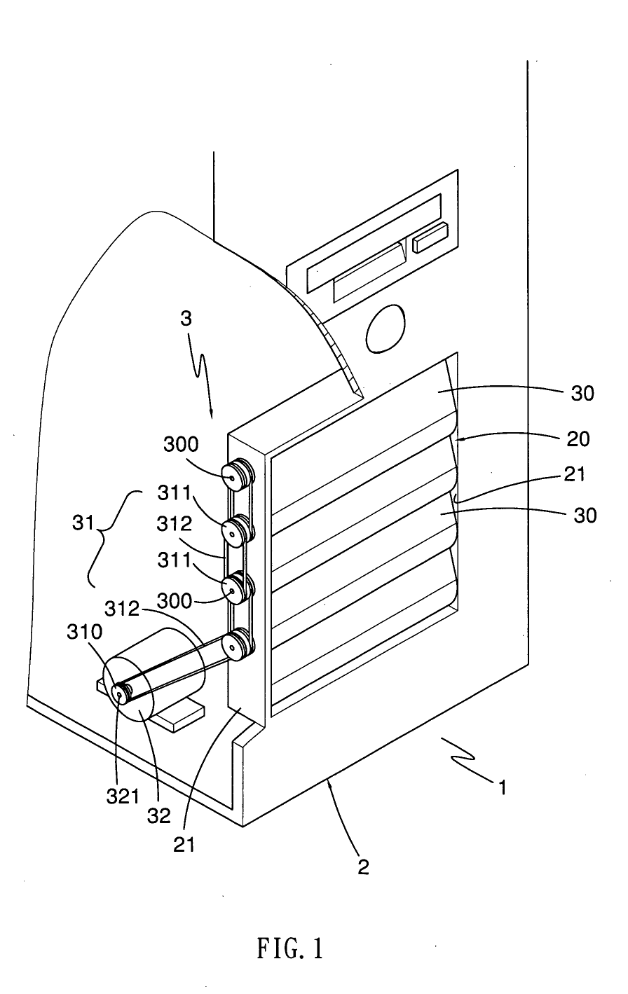

FIG. 1 shows a computer housing 1 as a first embodiment of the present invention and the computer housing 1 comprises a body 2 and a heat-dissipating gate 3. A front panel of the body 2 has an opening 20, which is a square opening and is formed with a holder 21 on each side of the opening 20.

In addition, the heat-dissipating gate 3 comprises a plurality of blades 30, a transmission device 31 and a motor 32. Each of the blades 30 has a shaft 300, which is connected with two opposite holders 21. Therefore, the blades 30 are rotatable upon the shaft 300. The transmission device 31 is preferably a belt transmission device, which is noiseless during operation. The transmission device 31 is provided for transmitting the blades 30 to rotate synchronously, and comprises an active belt wheel 310, a plurality of passive belt wheels 311 and a plurality of belts 312. The active belt wheel 310 is fixed to a power-output shaft 321 of the motor 32 and each of the passive belt wheels 311 is correspondingly fixed to the shaft 300 of each blade 30. Furthermore, the belts 312 are provided for interconnecting the active belt wheel 310 and the passive belt wheels 311, so as to synchronize the active belt wheel 310 and the passive belt wheels 311. More specifically, as shown in FIG. 1, one of the belts 312 winds around the active belt wheel 310 and one of the passive belt wheels 311, and each of the passive belt wheels 311 and its adjacent ones of the passive belts wheels 311 are winded around by other belts 312.

The motor 32 is provided for driving the transmission device 31 according to an internal temperature of the body 2. When the motor 32 turns on, the blades 30 are transmitted to rotate synchronously by the transmission device 31, namely the power-output shaft 321, the active belt wheel 310, the passive belt wheels 311 and the belts 312. Therefore, an open status of the opening 20 is determined by a rotational degree of the blades 30 that is to say, the heat-dissipating gate 3 determining the open status of the opening 20.

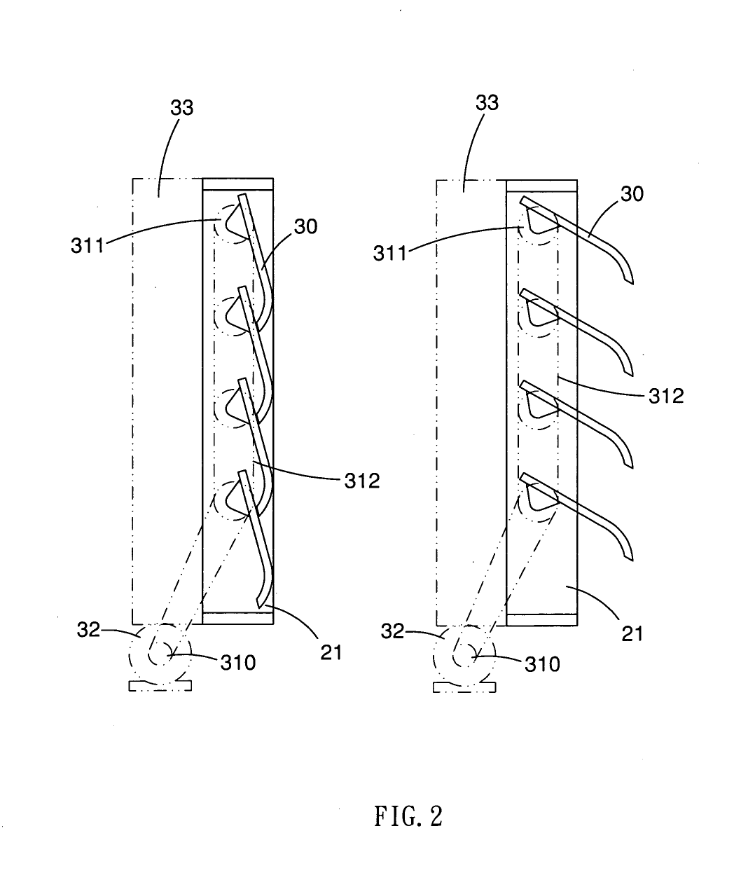

As shown in FIG. 2, the first embodiment of the present invention further comprises a fan 33, which is fixed to inner sides of the holders 21. When the blades 30 are rotated to form an open status, the fan 33 operates for generating airflows. On the contrary, the fan 33 stops operating when the blades 30 are rotated to form a close status. Therefore, as long as a heat-dissipating control function is installed in a computer host, a reversible rotation of the motor 32 can be controlled, according to the internal temperature of the body 2. This means that the internal temperature of the body 2 determines the open status of the heat-dissipating gate 3. When the internal temperature of the body 2 reaches to a high temperature, the heat-dissipating gate 3 is determined to be in a greatly open status or a fully open status, so as to dissipate the heat rapidly. When the internal temperature of the body 2 reaches to a low temperature, the heat-dissipating gate 3 is determined to be in a slightly open status or a fully close status, so as to reduce noises generated from the fan 33.

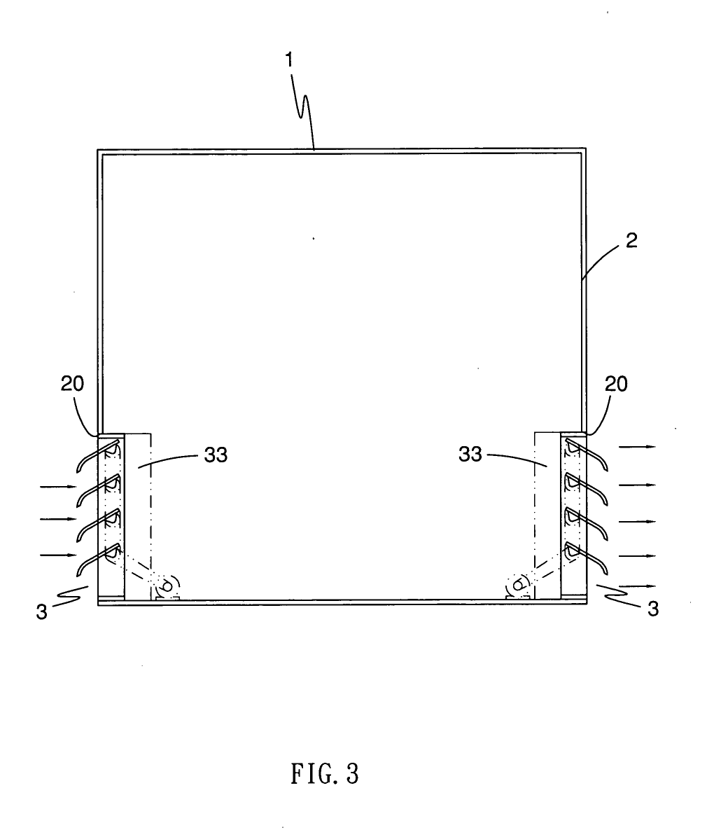

FIG. 3 shows a second embodiment of the present invention. The second embodiment is similar to the first embodiment except the second embodiment comprises two openings 20 and two heat-dissipating gates 3. In the second embodiment, the openings 20 are opposite to each other and the heat-dissipating gates 3 are respectively installed in the openings 20. Furthermore, one of the heat-dissipating gates 3 is provided for drawing outside air into the interior of the computer housing 1, and the opposite one of the heat-dissipating gates 3 is provided for sending the internal heat out of the computer housing 1. Therefore, the heat within the computer housing 1 is well dissipated by the heat-dissipating gates 3 and the air within the computer housing 1 is thereby circulated.

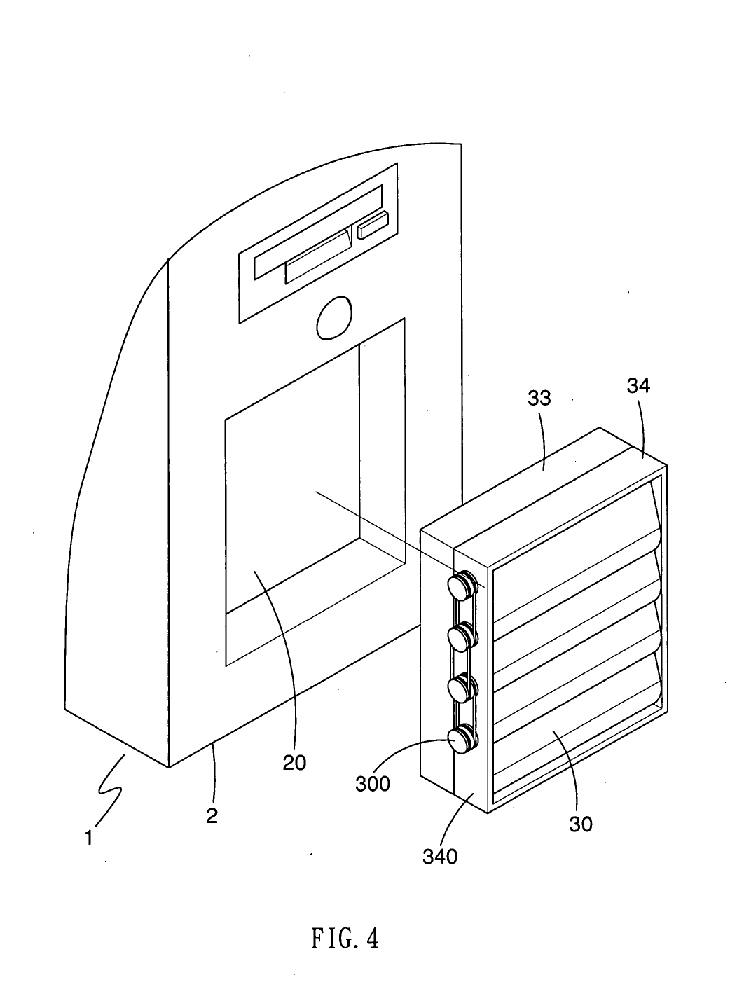

In FIG. 4, a third embodiment of the present invention is shown. The third embodiment is also similar to the first embodiment except the heat-dissipating gate 3 of the third embodiment comprises a frame 34. The frame 34 is provided for fixing to the opening 20 and for connecting to the fan 3. The frame 34 has two holders 340 respectively formed on two opposite sides of the frame 34, namely one of the holders 340 being opposite to the other one of the holders 340. The shafts 300 of the blades 30 are connected to the holders 340 respectively so that the blades 30 are rotatable between the holders 340.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A computer housing, comprising:
a body, having an opening and two holders respectively formed on two opposite sides of the opening; and
a heat-dissipating gate, comprising:
a plurality of blades, each of the plurality of blades having a shaft connected with the two holders, whereby the plurality of blades are rotatable between the two holders;
a transmission device, provided for transmitting the plurality of blades to rotate synchronously; and
a motor, provided for driving the transmission device according to an internal temperature of the body.

2. The computer housing of claim 1, wherein the heat-dissipating gate further comprises a fan fixed to the two holders.

3. The computer housing of claim 1, wherein the transmission device comprises:
an active belt wheel, fixed to a power-output shaft of the motor;
a plurality of passive belt wheels, each of the plurality of passive belt wheels being fixed to the shaft of each of the plurality of blades correspondingly; and
a plurality of belts, provided for interconnecting the active belt wheel and each of the plurality of passive belt wheels, so as to synchronize the active belt wheel and the plurality of passive belt wheels.

4. The computer housing of claim 2, wherein the transmission device comprises:
an active belt wheel, fixed to a power-output shaft of the motor;
a plurality of passive belt wheels, each of the plurality of passive belt wheels being fixed to the shaft of each of the plurality of blades correspondingly; and
a plurality of belts, provided for interconnecting the active belt wheel and each of the plurality of passive belt wheels, so as to synchronize the active belt wheel and the plurality of passive belt wheels.

5. A computer housing, comprising:
a body, having two openings, each of the two openings formed two holders respectively on two opposite sides of each of the two openings; and
two heat-dissipating gates, each of the two heat-dissipating gates comprising:
a plurality of blades, each of the plurality of blades having a shaft connected with the two holders of each of the two openings, whereby the plurality of blades are rotatable between the two holders of each of the two openings;
a transmission device, provided for transmitting the plurality of blades to rotate synchronously; and
a motor, provided for driving the transmission device according to an internal temperature of the body.

6. The computer housing of claim 5, wherein each of the two heat-dissipating gates further comprises a fan fixed to the two holders of each of the two openings.

7. The computer housing of claim 6,wherein one of the two openings is opposite to other one of the two openings.

8. The computer housing of claim 5, wherein the transmission device comprises:
an active belt wheel, fixed to a power-output shaft of the motor;
a plurality of passive belt wheels, each of the plurality of passive belt wheels being fixed to the shaft of each of the plurality of blades correspondingly; and
a plurality of belts, provided for interconnecting the active belt wheel and each of the plurality of passive belt wheels, so as to synchronize the active belt wheel and the plurality of passive belt wheels.

9. The computer housing of claim 6, wherein the transmission device comprises:
an active belt wheel, fixed to a power-output shaft of the motor;
a plurality of passive belt wheels, each of the plurality of passive belt wheels being fixed to the shaft of each of the plurality of blades correspondingly; and
a plurality of belts, provided for interconnecting the active belt wheel and each of the plurality of passive belt wheels, so as to synchronize the active belt wheel and the plurality of passive belt wheels.

10. A heat-dissipating gate, comprising:
two holders;
a plurality of blades, each of the plurality of blades having a shaft connected with the two holders, whereby the plurality of blades are rotatable between the two holders;
a plurality of passive belt wheels, each of the plurality of passive belt wheels being fixed to the shaft of each of the plurality of blades correspondingly; and
a plurality of belts, provided for interconnecting each of the plurality of passive belt wheels, so as to synchronize the plurality of passive belt wheels.

11. The heat-dissipating gate of claim 10, further comprising a fan fixed to the two holders.
